(19) United States
(12) Patent Application Publication
(10) Pub. No.: US 2026/0189331 A1
(43) Pub. Date: Jul. 2, 2026

(54) METHOD AND SYSTEM FOR DOWNLINK SYNCHRONIZATION IN WIRELESS NETWORKS

(71) Applicant: Samsung Electronics Co., Ltd., Suwon-si, Gyeonggi-do (KR)

(72) Inventors: Mohammed Saquib Noorulhuda KHAN, Bangalore (IN); Anusha GUNTURU, Bangalore (IN); Ashok Kumar Reddy CHAVVA, Bangalore (IN)

(21) Appl. No.: 19/126,032

(22) PCT Filed: Oct. 31, 2023
(86) PCT No.: PCT/KR2023/017093

§ 371 Date: Apr. 30, 2025

(30) Foreign Application Priority Data
Oct. 31, 2022 (IN) 202241061946
Sep. 26, 2023 (IN) 202241061946

(51) Int. Cl. H04L 5/00; H04J 13/00

(52) U.S. Cl. CPC H04L 5/0044; H04J 13/0062; H04J 2013/0085

(57) ABSTRACT

The disclosure relates to a 5G or 6G communication system for supporting a higher data transmission rate and relates to a method and system for downlink synchronization in a wireless network, more particularly, the disclosed method and system relate to downlink synchronization technique design for Orthogonal Time Frequency Space (OTFS) cellular systems.

### TECHNICAL FIELD

The present disclosure relates to wireless communication and relates to a method and system for downlink synchronization in a wireless network. More particularly, the disclosed method and system relate to downlink synchronization technique design for Orthogonal Time Frequency Space (OTFS) cellular systems.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

With the deployment of fifth-generation (5G) wireless networks, sixth-generation (6G) networks are currently under development and standardization. In this transition, 6G is expected to integrate and provide ubiquitous reliable connections to numerous highly mobile terminals, such as autonomous vehicles (terrestrial, aerial, and underwater), high-speed train (HST), and low-earth-orbit (LEO) satellites. However, communication in high-mobility scenarios suffers from severe channel Doppler spreads, which is mainly caused by the relative motion between the transmitter, receiver, and scatterers.

Currently, orthogonal frequency division multiplexing (OFDM) is the dominant modulation technique in 4G and 5G networks and is significantly affected in high-mobility environments. Therefore, an alternative modulation technique called orthogonal time-frequency space (OTFS) has recently been developed. Unlike the time-frequency domain symbol mapping in OFDM, OTFS is processed in the delay-Doppler domain, which has a strong delay and Doppler flexibility while also enjoying the potential of full diversity. In OTFS modulation, the delay domain is T seconds wide with M partitions of T/M seconds each, and the Doppler domain is Δf=1/T Hz wide with N partitions of Δf/N Hz each. The N×M partitions from one delay-Doppler resource block (DDRB) and each combination of a partition in the delay-Doppler domain form a delay-Doppler resource element (DDRE). In some existing systems, it has been shown that even in the Doppler spread-induced channel, the information symbol transmitted on a DDRE in OTFS does not spread to other DDREs as much as the information symbol transmitted on a time-frequency domain subcarrier spreads over all other subcarriers in OFDM. Instead, the information symbol fairly shifts from one DDRE to another without any loss of information. This offset in the delay domain is equal to the delay of some channel path, and in the Doppler domain, the offset is equal to the Doppler shift of the same channel path. Moreover, each information symbol in the delay-Doppler domain sees the same constant channel gain. Thus, OTFS modulation is more robust to channel-induced Doppler spread when compared to OFDM for reliable communication.

The conventional OTFS systems are focused on delay-Doppler channel estimation, multiple-input multiple-output (MIMO), multiple access, and equalization, but not on synchronization. Specifically, conventional systems consider an ideal synchronization condition or synchronization with the conventional OFDM-based technique to detect OTFS information symbols. In high mobility scenarios, synchronization is not only a critical issue for the terrestrial user equipment (UE; such as vehicles and HST), it is even severe for unmanned aerial vehicles (UAVs). According to some existing systems, UAVs suffer downlink interference from a large number of cells and endure greater cell edge conditions than a typical terrestrial UE owing to the high line-of-sight (LOS) propagation probability.

It is not easy to perform symbol timing (ST) and cell identity (CID) detection with the received preamble in a high-Doppler environment. A high Doppler shift produces a large ambiguity in the timing estimation and CID detection. In 5G, a UE is used to detect the primary synchronization signal (PSS) and secondary synchronization signal (SSS) transmitted from the base station (BS) in a synchronization signal block for ST and CID detection. However, the conventional OFDM-based NR system is sensitive to high Doppler and fails to provide accurate timing synchronization in high-mobility scenarios. By increasing the subcarrier spacing, Doppler sensitivity can be reduced but at the cost of higher bandwidth and higher processing time due to correlation with multiple numerologies. Thus, it is desired to have a downlink synchronization technique using OTFS.

In some existing systems, a downlink synchronization and CID estimation technique were proposed. Here, each BS transmits a detection preamble (DP) based on a linear frequency-modulated waveform carrying a primary CID (PCID) signal and two OTFS symbols, which comprise two DDRBs: a pilot DDRB and a secondary-CID (SCID) signal (SS) DDRB based on Zadoff-Chu sequence (ZCS). Though this technique provides robust performance in a high-Doppler environment, it uses time-domain linear-frequency modulated (LFM) waveform as PSS and multiplexed with the time-domain OTFS signals and possesses high complexity due to the coherent detection of PCID and SCID and the use of a message-passing algorithm.

Thus, it is desired to address the above-mentioned disadvantages or other shortcomings or at least provide a useful alternative for downlink synchronization technique design using orthogonal time frequency space (OTFS).

### DISCLOSURE OF INVENTION

### Technical Problem

In line with development of the communication systems, there is a need for performing downlink synchronization in a wireless network

The technical subjects pursued in the disclosure may not be limited to the above mentioned technical subjects, and other technical subjects which are not mentioned may be clearly understood, through the following descriptions, by those skilled in the art to which the disclosure pertains.

### Solution to Problem

According to another embodiment of the present disclosure, disclosed is a method for performing downlink synchronization in a wireless network. The method includes generating, by a network entity associated with the wireless network, a plurality of synchronization signals based on a pseudorandom sequence. Further, the method includes mapping the plurality of synchronization signals in delay-Doppler (DD) domain to determine a two-dimensional delay-Doppler resource block (DDRB). Furthermore, the method includes transforming the mapped synchronization signals to the time-frequency (TF) domain to obtain a hybrid frame associated with the plurality of synchronization signals. Moreover, the method includes generating a downlink frame by transforming the hybrid frame from TF domain to the time domain. Finally, the method includes transmitting the downlink frame to a user equipment (UE) for performing downlink synchronization.

According to another embodiment of the present disclosure, disclosed is a system for performing downlink synchronization in a wireless network. The system comprises a memory, and a processor coupled with the memory. The processor is configured to generate, by a network entity associated with the wireless network, a plurality of synchronization signals based on a pseudorandom sequence. Further, the processor is configured to map the plurality of synchronization signals in delay-Doppler (DD) domain to determine a two-dimensional delay-Doppler resource block (DDRB). Further, the processor is configured to transform the mapped synchronization signals to time-frequency (TF) domain to obtain a hybrid frame associated with the plurality of synchronization signals. Further, the processor is configured to generate a downlink frame by transforming the hybrid frame from the TF domain to the time domain. Further, the processor is configured to transmit the downlink frame to a UE for performing downlink synchronization.

According to another embodiment of the present disclosure, disclosed is a method for performing downlink synchronization in a wireless network. The method includes receiving, by a user equipment (UE), a downlink frame transmitted by a network entity. Further, the method includes determining a primary synchronization signal (PSS) based on a time domain correlation of the downlink frame with the locally generated PSS using one or more parallel correlators to determine a start position of the received downlink frame and a primary cell identity (PCID) corresponding to the PSS. Further, the method includes determining a frequency offset based on correlation using the one or more parallel correlators for performing frequency correction on the received downlink frame. Further, the method includes transforming the frequency corrected received downlink frame in delay-Doppler domain. Further, the method includes extracting, from the transformed downlink frame in delay-Doppler domain, a secondary synchronization signal (SSS) based on a predefined mapping scheme. Further, the method includes performing 2D delay-Doppler correlation of the extracted SSS with a locally generated SSS to determine a secondary cell identity (SCID) corresponding to the SSS. Further, the method includes performing downlink synchronization and cell identity estimation using the determined PSS and the extracted SSS.

According to another embodiment of the present disclosure, disclosed is a system for performing downlink synchronization in a wireless network. The system comprises a memory, and a processor coupled with the memory. The processor is configured to receive, by a user equipment (UE), a downlink frame transmitted by a network entity. Further, the processor is configured to determine a primary synchronization signal (PSS) based on a time domain correlation of the downlink frame with the locally generated PSS using one or more parallel correlators to determine a start position of the received downlink frame and a primary cell identity (PCID) corresponding to the PSS. Further, the processor is configured to determine a frequency offset based on correlation using the one or more parallel correlators for performing frequency correction on the received downlink frame. Further, the processor is configured to transform the frequency corrected received downlink frame in delay-Doppler domain. Further, the method includes extracting, from the transformed downlink frame in delay-Doppler domain, a secondary synchronization signal (SSS) based on a predefined mapping scheme. Further, the processor is configured to perform 2D delay-Doppler domain correlation of the extracted SSS with a locally generated SSS to determine a secondary cell identity (SCID) corresponding to the SSS. Further, the processor is configured to perform downlink synchronization and cell identity estimation using the determined PSS and the extracted SSS.

According to another embodiment of the present disclosure, disclosed is a method for performing downlink synchronization in a wireless network. The method includes partitioning a downlink frame, received by a user equipment (UE), into one or more blocks, wherein each block includes L_{I} samples. Further, for each block of the one or more blocks the method includes padding the corresponding block with L_{I} zeros at the beginning and transforming the padded corresponding block into the frequency domain of size 2L_{I}. Further, the method includes extending a locally generated primary synchronization signal (PSS) by appending L_{I} zeros at the end of the locally generated PSS. Further, the method includes performing frequency domain transformation and conjugation on the extended zeros padded locally generated PSS. Further, the method includes performing correlation of padded block in frequency domain with the extended locally generated PSS by multiplication and transformation in time-domain. Further, the method includes overlapping the one or more blocks in time domain to obtain a cell identity and a frame timing corresponding to a PSS in the received downlink frame.

According to another embodiment of the present disclosure, disclosed is a system for performing downlink synchronization in a wireless network. The system comprises a memory, and a processor coupled with the memory. The processor is configured to partition a downlink frame, received by a user equipment (UE), into one or more blocks, wherein each block includes L_{I} samples. Further, for each block of the one or more blocks the method includes padding the corresponding block with L_{I} zeros at the beginning and transforming the padded corresponding block into the frequency domain of size 2L_{I}. Further, the processor is configured to extend a locally generated primary synchronization signal (PSS) by appending L_{I} zeros at the end of the locally generated PSS. Further, the processor is configured to perform frequency domain transformation and conjugation on the extended zeros padded locally generated PSS. Further, the processor is configured to perform correlation of padded block in frequency domain with the extended locally generated PSS by multiplication and transformation in time-domain. Further, the processor is configured to overlap the one or more blocks in time domain to obtain a cell identity and a frame timing corresponding to a PSS in the received downlink frame.

To further clarify the advantages and features of the present disclosure, a more particular description of the disclosure will be rendered by reference to specific embodiments thereof, which is illustrated in the appended drawings. It is appreciated that these drawings depict only typical embodiments of the disclosure and are therefore not to be considered limiting of its scope. The disclosure will be described and explained with additional specificity and detail with the accompanying drawings.

### Advantageous Effects of Invention

The present disclosure provides an effective and efficient method for performing downlink synchronization in a wireless network. Advantageous effects obtainable from the disclosure may not be limited to the above mentioned effects, and other effects which are not mentioned may be clearly understood, through the following descriptions, by those skilled in the art to which the disclosure pertains.

### BRIEF DESCRIPTION OF DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram illustrating synchronization procedure in 5G wireless networks, according to the existing art;

FIG. 2 illustrates the angle between a base station (BS) and UE, according to the existing art;

FIG. 3 is a pictorial diagram illustrating an environment 300 for downlink synchronization, according to an embodiment of the present disclosure;

FIG. 4 is flow diagram illustrating the proposed synchronization procedure, according to embodiments of the present disclosure;

FIG. 5 is schematic diagram depicting an intermediate hybrid frame with synchronization signals mapped in DD domain and data in TF domain, according to embodiments of the present disclosure;

FIG. 6 is a schematic diagram depicting hybrid frame with DD domain synchronization signals transformed and mapped in TF domain with all slots configured as downlink, according to an embodiment of the present disclosure;

FIG. 7 is a schematic diagram depicting exemplary mapping of synchronization signal in DD domain, according to an embodiment of the present disclosure;

FIGS. 8A-8C depict exemplary mapping schemes for mapping synchronization signals, according to an embodiment of the present disclosure;

FIG. 9 is a schematic diagram depicting the overlap-add method P2 for PSS detection, according to an embodiment of the present disclosure;

FIG. 10 is a schematic diagram depicting a plotting of the number of complex multiplications required by methods P1 and P2 respectively, according to an embodiment of the present disclosure;

FIG. 11 is a schematic diagram depicting the detection probabilities of PSS by P2 under AWGN and TDL-C, according to an embodiment of the present disclosure;

FIG. 12 is a schematic diagram depicting the comparative detection probabilities of the PSS using the OTFS and OFDM techniques, according to an embodiment of the present disclosure;

FIG. 13 is a schematic diagram illustrating the correlation properties of the 2D delay-Doppler ZCS, according to an embodiment of the present disclosure;

FIG. 14 is a schematic diagram illustrating the comparative detection probabilities of the SCID using the OTFS and OFDM techniques, according to an embodiment of the present disclosure;

FIG. 15 is a flow diagram depicting the method for performing downlink synchronization, according to an embodiment of the present disclosure;

FIG. 16 is a flow diagram depicting the method for performing downlink synchronization, according to an embodiment of the present disclosure;

FIG. 17 is a flow diagram depicting the method for performing downlink synchronization, particularly PSS detection by P2, according to an embodiment of the present disclosure; and

FIG. 18 is a block diagram depicting an overall system for implementing the proposed techniques for performing downlink synchronization, according to an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### MODE FOR THE INVENTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment”, and similar language throughout this specification may, but do not necessarily, all refer to the same embodiment.

The terms “comprise”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks that carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the invention. Likewise, the blocks of the embodiments may be physically combined into more complex blocks without departing from the scope of the invention

The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

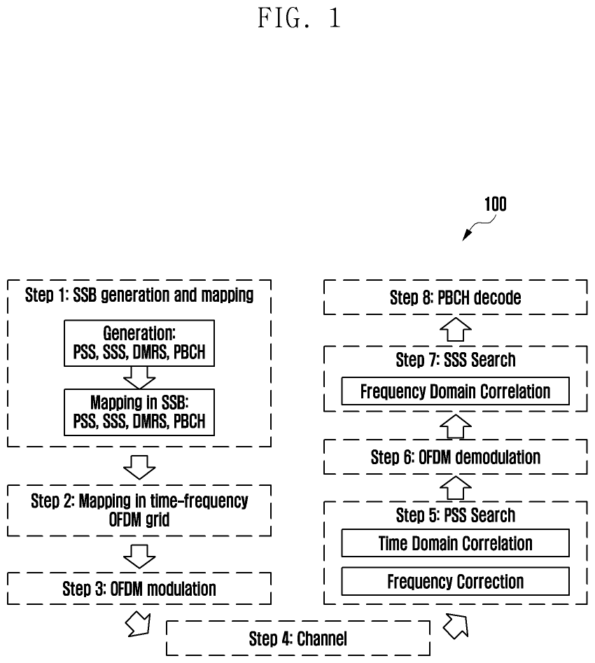

FIG. 1 is a schematic diagram illustrating synchronization procedure in 5G wireless networks, according to the existing art. At step 1, a base station (BS) generates synchronization signals such as, but not limited to, primary synchronization signal (PSS), secondary synchronization signal (SSS), demodulation reference signal (DMRS), Physical Broadcast Channel (PBCH). The BS generates the synchronization signals to enable UE to establish and maintain a reliable connection, for seamless communication and data transmission within a cellular network. The generated synchronization signals are then mapped in the synchronization signal block (SSB). At step 2, the SSB is mapped in a time frequency orthogonal frequency division multiplexing (OFDM) grid. Mapping in the time-frequency OFDM grid involves arranging data symbols onto subcarriers in discrete time intervals (symbols) and specific frequency subchannels, to ensure orthogonal transmission, efficient use of spectrum, and robust data delivery in wireless communication systems. Data symbols refer to discrete units of data that represent information in digital communication systems. Further, time intervals (symbols) refer to discrete units of time during which data is transmitted or received. At step 3, OFDM modulation is applied to the SSB mapped in the OFDM grid. The OFDM modulation technique divides a high-data-rate signal into multiple subcarriers, each transmitting a portion of the data in parallel, allowing for efficient use of available bandwidth and improved resistance to channel impairments like multipath interference. Steps 1 through 3 are performed at the BS.

At step 4, the OFDM-modulated SSB is transmitted over a communication channel. Thereafter, steps 5 through 8 are performed at the UE for detecting PSS and SSS, before being able to communicate with the network. At step 5, the UE performs a PSS search by performing time domain correlation to detect the PSS sequence in the received signal and performing frequency correction to synchronize the local oscillator of the UE with the carrier frequency of the cell containing the PSS. At step 6, OFDM demodulation is performed to extract information from the OFDM-modulated signal received from the communication channel. At step 7, an SSS search is performed by the UE using frequency domain correlation, to accurately identify and synchronize with the cell associated with the BS. After performing the SSS search, the UE, at step 8 decodes PBCH (Physical Broadcast Channel) to obtain essential system information such as, but is not limited to, cell identity, master information block (MIB), and system information block (SIB).

Thus, before communication with the network, the UE must perform cell search and selection procedures and obtain initial system information. The first steps in such cell search and selection process are acquiring frame synchronization, finding out the cell identity, and decoding the MIB and SIB1. In some cases, when the UE is highly mobile, detection of synchronization signal using the cell search and selection process may be inefficient.

In the existing art, a transition from 5G to Beyond 5G (B5G) and 6G is expected to integrate and provide ubiquitous reliable connections to numerous highly mobile terminals. Examples of such highly mobile terminals may include, but not limited to, autonomous vehicles of speeds up to 300 km/h for vehicle-to-vehicle and vehicle-to-infrastructure systems, a high-speed train (HST) applications for the speed up to 400 km/h, and low-earth-orbit (LEO) satellites. B5G and 6G may support Terahertz (THz) communications (0.1˜10 THz) with huge bandwidth and high-velocity applications. However, both the high carrier frequency operation (0.1˜10 THz) and high velocities (up to 400 Kmph) induce severe Doppler in the signal observed by the UE.

In the existing art associated with 4G/5G systems, the OFDM may be a dominant modulation technique to provide broadband services to a large population. However, in an environment with highly mobile terminals, OFDM performance significantly deteriorates as the channel estimation is not effective in the high Doppler environment and fails completely when the Doppler frequency is larger than half of the subcarrier spacing (SCS).

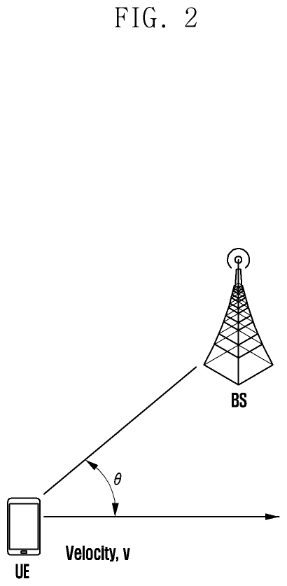

The frequency f, observed at the receiver with Doppler frequency shift fa can be written as equation (1) below.

$${f}_{r} = {f}_{c} + {f}_{d} = {f}_{c} + ( \frac{v cos θ}{c} ) {f}_{c} \qquad ( 1 )$$

where fc is the carrier frequency, c is the speed of light and θ is the angle between a base station (BS) and UE as shown in FIG. 2.

Further, due to the Doppler frequency shift, the OFDM systems suffer severe inter carrier interference (ICI) which gets more severe with the increase in velocity. Therefore, an objective of the present disclosure is to identify either a new waveform other than OFDM or changes to the existing waveform that can mitigate the high Doppler effects for high-speed applications and high carrier frequencies in the next-generation technologies.

To mitigate the ICI at millimetre-wave (mmWave), SCS as high as 240 kHz is introduced in 5G NR for OFDM waveform. However, high mobility combined with mmWave frequencies can increase the ICI further, degrading the signal-to-noise ratio (SNR) at the receiver, and affecting the performance. Thus, increasing the SCS further to mitigate the ICI reduces the ability to handle inter-symbol interference (ISI) for a fixed cyclic prefix (CP) ratio because of the reduced OFDM symbol duration. However, increasing CP may result in the reduction of spectral efficiency. Thus, an objective of the present disclosure is to consider a new waveform for B5G and 6G systems to support high-speed applications.

Since synchronization is the first step to establish the connection between the BS and UE, frame symbol timing (ST) and Cell ID (CID) estimations are effected due to Doppler in the OFDM systems. Therefore, an objective of the present disclosure is to define a delay-Doppler (DD) domain Synchronization Signal design that can be used for ST and CID detections in a high-Doppler environment.

Accordingly, embodiments herein describe a method and system for a downlink synchronization using orthogonal time-frequency space (OTFS) at a physical layer. Here, the base station (BS) broadcasts synchronization signals i.e., primary cell identity (PCID) and a secondary cell identity (SCID) that are mapped in the two-dimensional (2D) delay-Doppler domain, which are identified by a highly mobile user equipment (UE). According to the embodiments of the present disclosure, the UE does not require channel estimation or equalization to detect PCID and SCID, unlike OFDM. As a result, the UE can more easily and less computationally determine the PCID and SCID from multiple BSs.

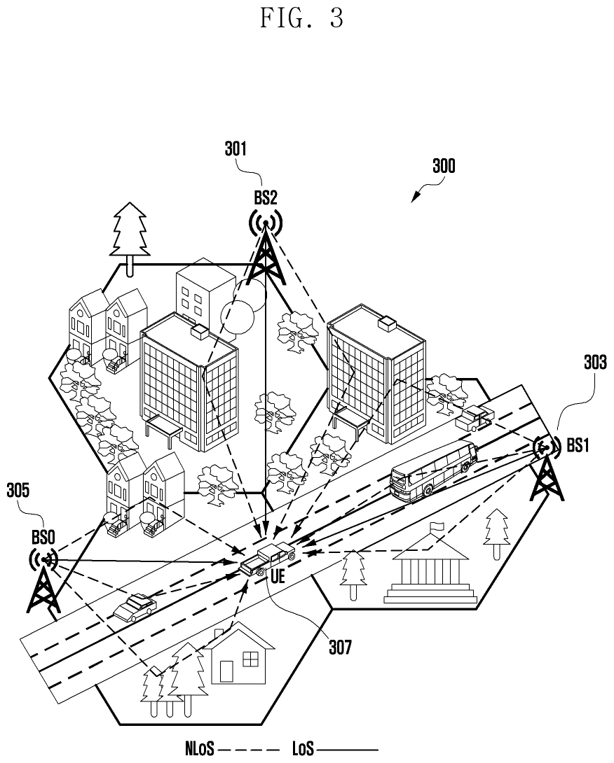

Embodiments of the present disclosure are now described in conjunction with FIGS. 3 through 19.

FIG. 3 is a pictorial diagram illustrating an environment 300 for downlink synchronization, according to an embodiment of the present disclosure. The environment 300 depicts a cellular system with three adjacent BSs 301-305, located at their predefined locations as shown in FIG. 3. The BSs may be broadcasting respective downlink frames which are received by a UE 307 that is moving on a trajectory from one BS to another BS and performing cell search. With the downlink signals received from adjacent BSs 301-305, the UE 307 may perform synchronization and CID estimation to detect the serving cell. The UE 307 may be receiving superimposed signals from multiple paths such that each path may be observing different delay and Doppler values. Such superimposed signals along with ICI, create an ambiguity in the detection of CID and ST.

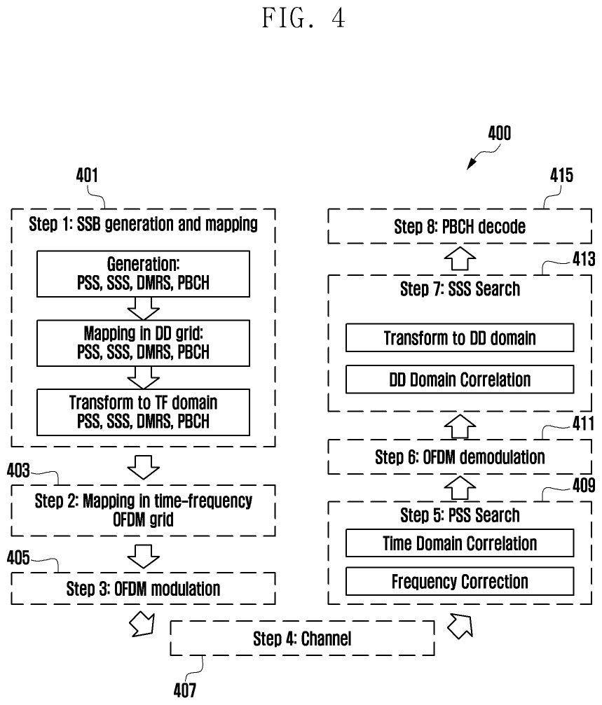

FIG. 4 is flow diagram illustrating the proposed synchronization procedure 400, according to embodiments of the present disclosure. The steps 1-3 of the synchronization procedure 400 are performed at a BS, while the steps 5-8 are performed at a UE. Unlike the conventional synchronization procedure, where the BS generates a plurality of synchronization signals and maps the generated signals in SSB, in step 1 (depicted in block 401) of the synchronization procedure 400 the BS maps the generated synchronization signals in delay-Doppler (DD) domain to determine a two-dimensional delay-Doppler resource block (DDRB), and then transform the mapped synchronization signals to time-frequency (TF) domain to obtain a hybrid frame associated with the plurality of synchronization signals. In an embodiment, the plurality of synchronization signals are generated based on a pseudorandom sequence. In an embodiment, the pseudorandom sequence may correspond to at least one of Zadoff-Chu sequence (ZCS), m-sequence, and gold sequence based on a radio access technology being used in the wireless network, and a type of the plurality of synchronization signals, i.e., PSS, or SSS. For example, m-sequence or ZCS may be used for PSS, and gold sequence or m-sequence or ZCS may be used for SSS. The frame structure of the hybrid frame is described later in detail.

Thereafter, at step 2 (depicted in block 403), synchronization signals in TF domain in the hybrid frame are mapped to a TF OFDM grid. At step 3 (depicted in block 405), OFDM modulation is performed to the TF OFDM grid to generate a downlink frame. At step 4 (depicted in block 407), the OFDM-modulated hybrid frame is transmitted to the UE over a communication channel, for performing downlink synchronization.

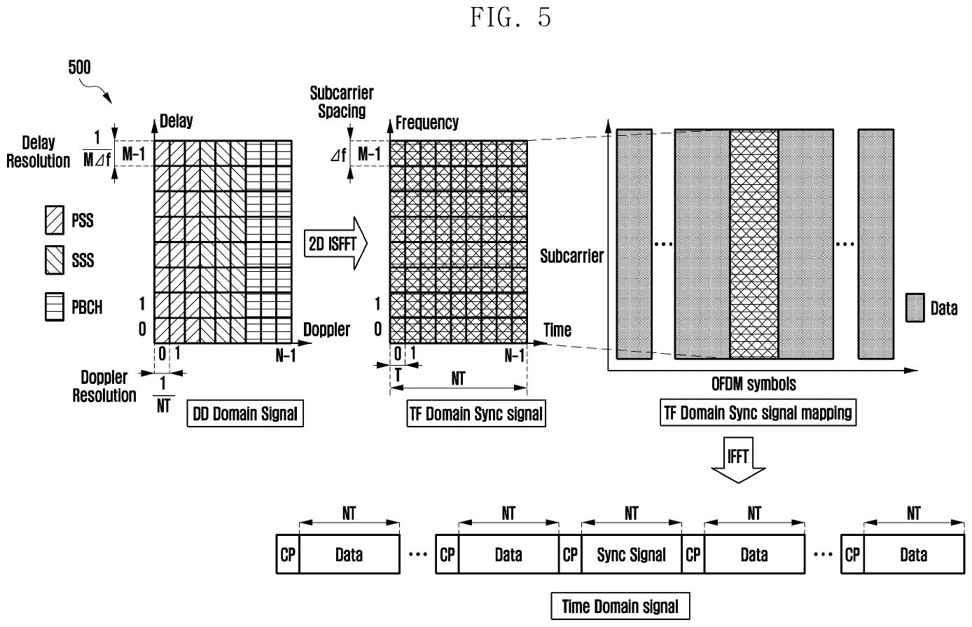

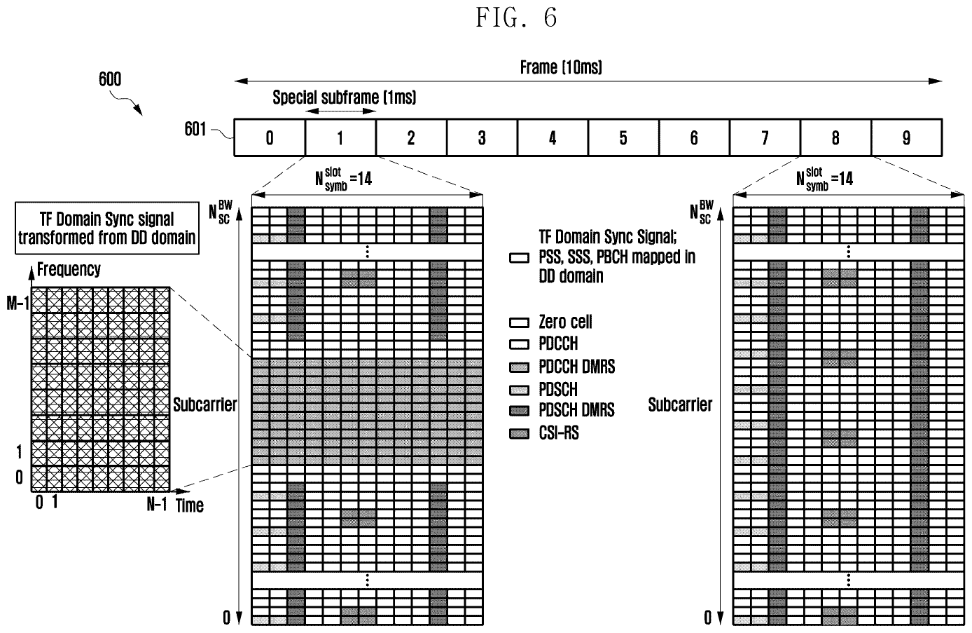

At step 5 (depicted in block 409), the UE performs downlink synchronization with the received signal by PSS search by performing time domain correlation to detect the PSS in the received signal and performing frequency correction to synchronize the local oscillator of the UE with the carrier frequency of the cell containing the PSS. In particular, the UE determines the PSS based on a time domain correlation of the downlink frame with a locally generated PSS using one or more parallel correlators to determine a start position of the received downlink frame and a primary cell identity (PCID) corresponding to the PSS, followed by determining a frequency offset based on correlation using the one or more parallel correlators for performing frequency correction on the received downlink frame. At step 6 (depicted in block 411), OFDM demodulation is performed to transform the time domain received signal to time-frequency domain. At step 7 (depicted in block 413), an SSS search is performed by the UE by transforming the frequency corrected received downlink frame in delay-Doppler domain, followed by extracting, from the transformed downlink frame in delay-Doppler domain, a secondary synchronization signal (SSS) based on a predefined mapping scheme, and then performing 2D delay-Doppler correlation of the extracted SSS with a locally generated SSS to determine a SCID associated with the extracted SSS. Finally, downlink synchronization is performed, and cell identity are estimated using the determined PSS and the extracted SSS. Thereafter, at step 8 (depicted in block 415), decoding of PBCH is performed to obtain essential system information such as, but is not limited to cell identity, master information block (MIB), and system information block (SIB). Now, the frame structure of the hybrid frame generated by the BS will be described below in conjunction with FIGS. 5-6.

FIG. 5 is schematic diagram 500 depicting an intermediate hybrid frame with synchronization signals mapped in DD domain and data in TF domain, according to embodiments of the present disclosure. FIG. 6 is a schematic diagram 600 depicting hybrid frame 601 with DD domain synchronization signals transformed and mapped in TF domain with all slots configured as downlink, according to an embodiment of the present disclosure. During the synchronization, the UE detects the PSS and SSS transmitted from the BS in a synchronization signal block for ST and CID detection. According to the embodiments of the present disclosure, as discussed above, each BS, of the plurality of BSs, transmits a downlink synchronization frame comprising a PSS and an SSS. The PSS and SSS may be generated in DD domain with M resource elements (Res) in the delay domain and N Res in Doppler domain each, as shown in the FIG. 5.

The generated PSS and SSS are then transformed to TF domain and mapped in the OFDM grid to transform in time-domain to get final time-domain signal. Said transformation results in the hybrid frame structure where the DD domain synchronization signals are transformed in TF domain and data are mapped in TF domain. The PSS may be used to determine the ST and Primary CID (PCID, NID₂) at the UE by using a non-coherent detection scheme i.e., correlation-based between the transmitted and received signals because the channel state information and timing information are not available at the start of synchronization. The SSS may be used to determine the Secondary CID (SCID, NID₁).

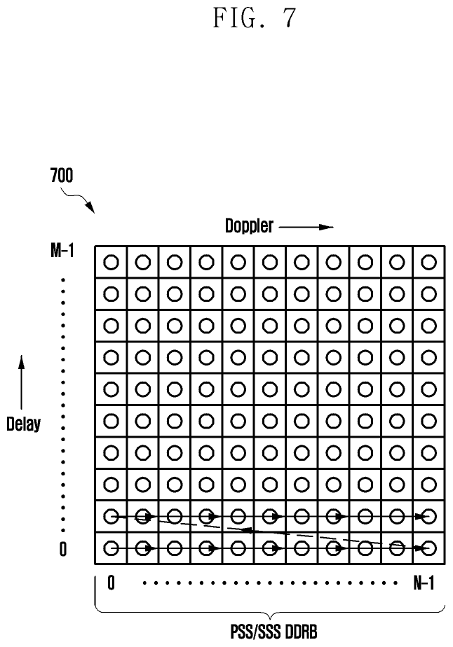

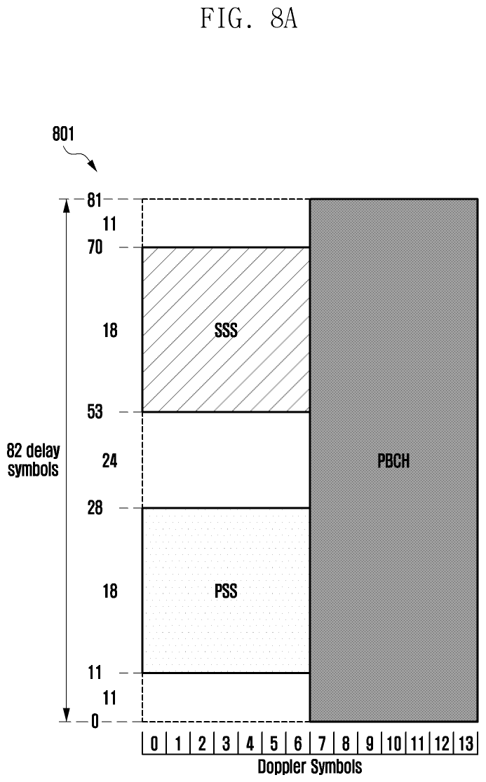

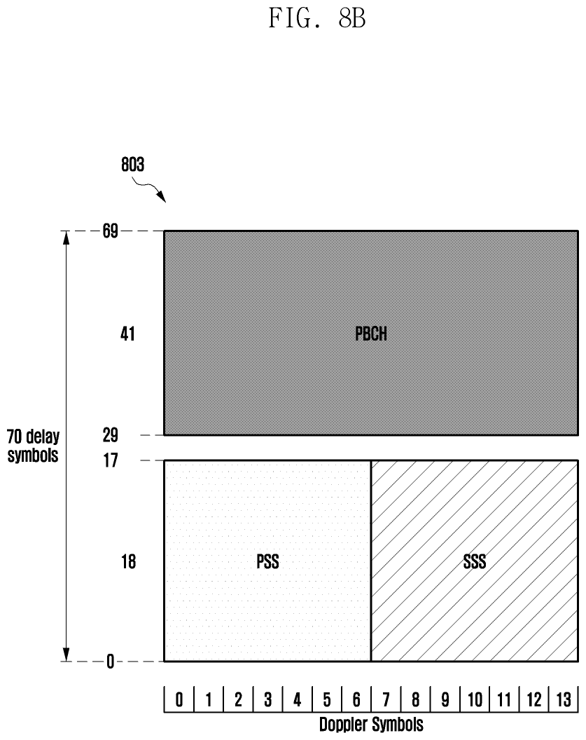

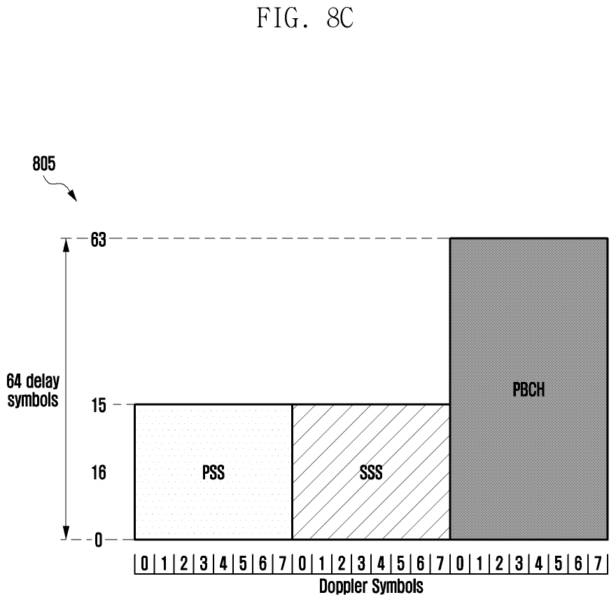

As shown in FIG. 6, the outer frame of the synchronization signal can be any frame i.e., OFDM or OTFS or the like. The resultant time domain signal may be a single waveform (i.e., OTFS) or a combination of multiple waveforms (i.e., OTFS+OFDM). Mapping Signals in DD domain provides strong delay-resilience and Doppler-resilience, while enjoying the potential of full diversity, which is the key to supporting reliable communications. Additionally, when the DD signals are transformed, it spread across both time and frequency, which mitigates the effects of channel fading and dispersion. The generation of synchronization signal and mapping steps performed at the BS are now explained in detail in conjunction with FIGS. 7-8C.

FIG. 7 is a schematic diagram 700 depicting exemplary mapping of synchronization signal in DD domain, according to an embodiment of the present disclosure. As discussed above, the synchronization signal may be generated based on pseudorandom sequence. In an exemplary embodiment of the present disclosure, FIG. 7 depicts the mapping of ZCS in DD domain for synchronization signal. The synchronization signal, i.e., PSS and SSS, may be mapped to the 2-dimensional DD resource block (DDRB) with N partitions in Doppler domain and M partitions in the delay domain as shown in FIG. 8 such that (1+kM), where 0≤k<N and 0≤1<M. Further, sequences like m-sequence (in 5G) or Zadoff-Chu (in LTE) may be used for PSS and sequences like gold sequence (in 5G) or m-sequence (in LTE) or Zadoff-Chu (in LTE or 5G) may be used for SSS.

In an exemplary embodiment, the PSS may be mapped on a MN-length ZCS. The ZCS may be mapped to a DDRB with N partitions in Doppler domain and M partitions in the delay domain as equation (2)

$${x}^{u} [ k , l ] = {e}^{- \frac{j π u}{M N} ( l + k M ) ( l + k M + 1 )} \qquad ( 2 )$$

where 0≤k<N and 0≤1<M and the PCID is mapped to its root index u, 2≤u<MN.

According to embodiments of the present disclosure, the SSS may also be generated same as PSS provided, they are orthogonal or at least their respective root indices are relatively co-prime. After the generation and mapping, transformations are performed. In an exemplary embodiment, DD domain to TF domain transformation may be performed using Inverse Symplectic Fourier Transform (ISFFT), while the TF domain to time domain transformation may be performed using Inverse Discrete Fourier Transform (IDFT).

According to the embodiments of the present disclosure, the synchronization signals can be mapped using multiple mapping schemes in the DD domain, as depicted in FIGS. 8A-8C. FIGS. 8A-8C are schematic diagrams illustrating exemplary mapping schemes, according to an embodiment of the present disclosure. While FIGS. 8A-8C depict three exemplary schemes, any mapping scheme can be used such that parts of the synchronization signals are separated in the DDRB based on delay and Doppler symbols associated with time and frequency in time-frequency domain, respectively. In an embodiment of the present disclosure, for using any mapping scheme, the PSS and SSS are assumed to be orthogonal. As discussed above, DD domain to TF domain transformation may be performed using ISFFT, and the TF domain to time domain transformation may be performed using IDFT. Effects of OTFS modulation on ZCS are now described. DD domain to TF domain transformation using ISFFT is given below, in equation (3):

$${X}^{u} [ n , m ] = \frac{1}{M N} {\sum }_{k = 0}^{N - 1} {\sum }_{l = 0}^{M - 1} {x}^{u} [ k , l ] {e}^{j 2 π ( \frac{nk}{N} - \frac{m l}{M} )} = \frac{1}{M} {\sum }_{l = 0}^{M - 1} ( {e}^{- \frac{j 2 π}{MN} ( mN + n ) l} {e}^{- \frac{j π u}{MN} ( - {\tilde{u}}^{2} {n}^{2} + \tilde{u} n )} \frac{1}{N} {\sum }_{k = 0}^{N - 1} {x}^{u} [ k - \frac{\tilde{u} n}{M} , l ] ) = {e}^{\frac{j π u}{M N} \tilde{u} n ( \tilde{u} n - 1 )} \frac{1}{M} {\sum }_{l = 0}^{M - 1} {\hat{X}}^{u} [ 0 , l ] {e}^{- \frac{j 2 π}{M} ( \frac{mN + n}{N} ) l} = ( {x}^{u} [ 0 , \tilde{u} n ] ) * {\hat{x}}^{u} [ \frac{m N + n}{N} , 0 ] \qquad ( 3 )$$

ũ is the multiplicative inverse of u such that uũ mod MN=1, and (·)* denotes complex conjugate. Furthermore, TF domain to time domain transformation using IDFT is given below, in equation (4):

$${s}^{u} ( t ) = {\sum }_{m = 0}^{M - 1} {\sum }_{n = 0}^{N - 1} {X}^{u} [ n , m ] {e}^{j 2 π m Δ f ( t - n T )} , 0 \leq t < NT \qquad ( 4 )$$

$$= {\sum }_{l = 0}^{M - 1} ( {e}^{- \frac{j π u}{MN} ( {m}^{2} {M}^{2} {N}^{2} + m M N - 2 \tilde{u} mMN Δ f t )} \frac{1}{N} {\sum }_{k = 0}^{N - 1} ( {x}^{u} [ 0 , \tilde{u} n - umMN ] ) * {\hat{x}}^{u} [ \frac{mN + n}{N} , 0 ] )$$

$$= {\sum }_{l \leq 0}^{M - 1} ( {e}^{- \frac{j π u}{MN} ( mMN - \tilde{u} Δ f t ) ( m MN - \tilde{u} Δ f t + 1 ) - ( \tilde{u} Δ {f}^{2} {t}^{2} - \tilde{u} Δ f t )} \frac{1}{N} {\sum }_{k = 0}^{N - 1} {X}^{u} [ \tilde{u} n - u m M N , m ] )$$

$$= {e}^{\frac{j π u}{M N} \tilde{u} Δ f t ( \tilde{u} Δ f t - 1 )} {x}^{u} [ 0 , 0 ] {\sum }_{l = 0}^{M - 1} {e}^{- \frac{j π u}{M N} ( m MN - \tilde{u} Δ f t ) ( m MN - \tilde{u} Δ f t + 1 )}$$

$$= ( {x}^{u} [ 0 , \tilde{u} Δ f t ] ) * {x}^{u} [ 0 , 0 ] {s}^{u} ( 0 )$$

The equations (3) and (4) show the relationship between the DD ZC Sequence and TF ZC Sequence and the relationship between the DD ZC Sequence and time domain ZCS. It can be seen that OTFS modulation of a ZC sequence is another conjugated and time-scaled ZC Sequence. Now the signal received at UE is described below.

The signal received at the UE in the time domain is given as

$$\begin{matrix}r ( t ) = {\sum }_{c = 0}^{C - 1} \int \int {h}^{c} ( τ , υ ) {s}^{c} ( t - τ ) {e}^{j 2 π υ ( t - τ )} d τ d υ + w ( t ) \\ {=}^{Δ} {\sum }_{c - 0}^{C - 1} {\sum }_{p = 1}^{P} {β}_{p}^{c} {s}^{c} ( t - {τ}_{p}^{c} ) {e}^{j 2 π {υ}_{p}^{c} ( t - {τ}_{p}^{c} )} + w ( t ) ,\end{matrix} \qquad ( 5 )$$

where s^{c}(t) is the signal transmitted from the c^{th} BS, C is the number of BSs, and w(t) is the additive white Gaussian noise (AWGN).

The delay-Doppler channel for the c^{th} BS is given by,

$${h}^{c} ( τ , υ ) = {\sum }_{p = 1}^{P} {β}_{p}^{c} δ ( τ - {τ}_{p}^{c} ) δ ( υ - {υ}_{p}^{c} ) , \qquad ( 6 )$$

where

$$P , {β}_{p}^{c} ,$$

and δ(·) denote the number of paths, complex channel gain, and impulse function, respectively. In addition,

$${τ}_{p}^{c} = {l}_{p}^{c} / M Δ f and {υ}_{p}^{c} = ( {k}_{p}^{c} + {κ}_{p}^{c} ) / NT$$

are the delay and Doppler shift taps for the p^{th} path, with

$$0 ⩽ {τ}_{p}^{c} ⩽ {τ}_{max} , - {υ}_{max} ⩽ {υ}_{p}^{c} ⩽ {υ}_{max} , 0 ⩽ {l}_{p}^{c} \leq {l}_{max} ,$$

being the delay index of the p^{th} path, and

$$- {k}_{max} ⩽ {k}_{p}^{c} ⩽ {k}_{max} ,$$

being the Doppler index of the p^{th} path. Here, τₘₐₓ, vₘₐₓ, Iₘₐₓ, and kₘₐₓ denote the maximum delay spread, maximum Doppler spread, the largest index of delay tap, and largest index of Doppler tap, respectively. Besides,

$${K}_{p}^{C}$$

∈[−0.5, 0.5] denotes the fractional Doppler shift associated with the p^{th} path.

At the UE, r (t) in (5) gets sampled with a sampling rate of fₛ=1/Tₛ, and it becomes

$$r ( ς ) = {\sum }_{c = 0}^{C - 1} {\sum }_{p = 1}^{P} {β}_{p}^{c} {s}^{c} ( ς - \frac{{τ}_{p}^{c}}{{T}_{\text{?}}} ) {e}^{j 2 {πυ}_{p}^{\text{?}} {T}_{\text{?}} ( ϛ - \frac{{r}_{p}^{c}}{{T}_{\text{?}}} )} + w ( ς ) , \qquad ( 7 )$$

$$\text{?} \text{indicates text missing or illegible when filed}$$

where 0< [symbol] <MN and Tₛ is the sampling duration. The n^{th} OTFS symbol each consisting of M samples can be collected from (6) as

$$r ( nM + ℓ ) = {{\sum }^{C - 1}}_{c = 0} {{\sum }^{p}}_{p = 1} {β}_{ρ}^{c} {s}^{c} ( nM + ℓ - \frac{{τ}_{ρ}^{c}}{{T}_{\text{?}}} ) {e}^{j 2 {πυ}^{\text{?}} {T}_{\text{?}} ( nM + ℓ - \frac{\text{?}}{{T}_{\text{?}}} )} + w ( nM + ℓ ) , \qquad ( 8 )$$

$$\text{?} \text{indicates text missing or illegible when filed}$$

where 0≤l<M Now downlink synchronization performed at UE are now described below.

To perform downlink synchronization and estimate the (PCID, NID₂), time-domain correlation is performed between received signal and locally generated PSS. Based on the high correlation peak, ST and NID₂ are estimated. The PSS detection is the most computationally complex algorithm during synchronization and cell search. Using the conventional linear correlation is computationally complex specially for high mobility UEs. According to the embodiments of the present disclosure, two correlation methods are proposed named as ‘P1’ and ‘P2’. The method P1 is based on partial correlation method where one big correlator is divided into multiple small correlators. The method P2 is based on an overlap-add method. The partial correlation method, P1 is now described below.

At the UE, both the position of the start of the PSS, \hat{ρ} and the PCID, û are jointly estimated by correlating the received signal, r( [symbol] ) with all the local PSS, s^{u}( [symbol] ) as follows:

$$\hat{ρ} , \hat{u} = arg {max}_{ρ , u} {\vert {\sum }_{ς = 0}^{MN - 1} r ( ς + ρ ) {( {s}^{u} ( ς ) )}^{\text{?}} \vert}^{2} , 0 \leq ς \leq MN - 1 \qquad ( 9 )$$

$$\text{?} \text{indicates text missing or illegible when filed}$$

where s^{u}( [symbol] ) is the sampled version of equation (4). Conventionally, the partial correlation method is used in long-term evolution (LTE) systems and also in 5G NR to achieve robustness against carrier frequency offset (CFO). According to the embodiments of the present disclosure, the partial correlation may be constructed by shortening the sliding correlation window, in accordance with the equation (10), as follows:

$$\hat{ρ} , \hat{u} = arg {max}_{ρ , u} \frac{{{\sum }_{i = 0}^{I - 1} \vert {\sum }_{ς = {iL}_{i}}^{( i + 1 ) {L}_{I} - 1} r ( ς + ρ ) {( {s}^{u} ( ς ) )}^{\text{?}} \vert}^{2}}{{\sum }_{ς = 0}^{MN - 1} {\vert r ( ς + ρ ) \vert}^{2}} \qquad ( 10 )$$

$$\text{?} \text{indicates text missing or illegible when filed}$$

where L_{I}=MN/I denotes the sliding window length. The number of complex multiplication required by P1 is CIN_{S}MN, where:
C corresponds to number of PSS to be correlated
l corresponds to number of correlators
Ns corresponds to total number of samples

As appreciated by a person skilled in the art, when l=1, equation (10) becomes equation (9) provided the normalization term is ignored. In addition, implementing (10) typically requires l parallel correlators before combining all correlation outputs. For instance, when l=2, two linear-shift correlators are required which start at a different time index, and the offset between these two correlators is L_{I} samples. Thus, P1 can be written as equation (11)

$${Z}_{0} ( ρ ) + {Z}_{1} ( ρ ) = \frac{1}{{\sum }_{ς = 0}^{MN - 1} {\vert r ( ς + ρ ) \vert}^{2}} [ {\vert {\sum }_{ς = 0}^{{L}_{I - 1}} r ( ς + ρ ) {( {s}^{u} ( ς ) )}^{\text{?}} \vert}^{2} + {\vert {\sum }_{ς = 0}^{{L}_{I - 1}} r ( ς + {L}_{I} + ρ ) {( {s}^{u} ( ς + {L}_{I} ) )}^{\text{?}} \vert}^{2} ] \qquad ( 11 )$$

$$\text{?} \text{indicates text missing or illegible when filed}$$

The procedure outlined in (11) involves reducing the sliding window to L_{I} samples and partitioning each local time-domain PSS into two segments. In the first correlator Z0(ρ), the initial segment of the PSS, corresponding to the first L_{I} samples, is correlated with the received signal starting at [symbol] instant. In the second correlator Z1(ρ), the subsequent segment of the PSS, corresponding to the second L_{I} samples, is correlated with the received signal starting at ( [symbol] +L_{I})th instant.

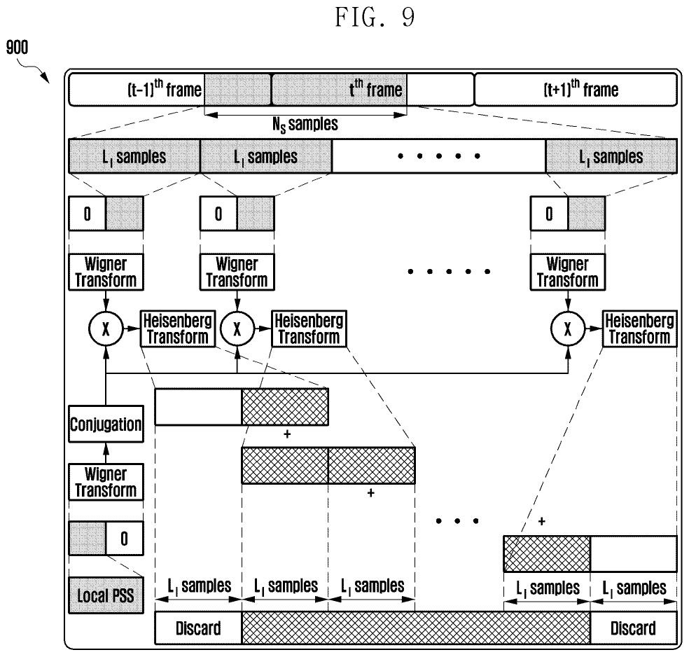

FIG. 9 is a schematic diagram 900 depicting the overlap-add method P2 for PSS detection, according to an embodiment of the present disclosure. As shown in FIG. 9, initially, the received downlink frame one or more blocks, such that each block includes L_{I} samples. Thereafter, for each block of the one or more blocks, following steps are performed:
padding corresponding block with L_{I} zeros at the beginning and transformed into the frequency domain via Wigner transform of size 2L_{I};
extending a locally generated PSS by appending L_{I} zeros at the end of the locally generated PSS;
performing frequency domain transformation and conjugation on the extended zeros padded locally generated PSS. In an embodiment, the domain transformation and conjugation may be performed using Wigner transform and conjugation; and
performing correlation of padded block in frequency domain with the extended locally generated PSS by multiplication and transformation in time-domain. In an embodiment, the transformation in time-domain may be performed using Heisenberg transform.

Finally, the resulting time-domain signals of each block are combined in an overlapped manner, and L_{I} samples from both ends are discarded. The last step results in the determination of a cell identity and a frame timing corresponding to a PSS in the received downlink frame. The number of complex multiplications required by P2 is

$$CI [ {CN}_{s} {log}_{2} ( 2 {IL}_{I} ) + 2 {IL}_{I} ] .$$

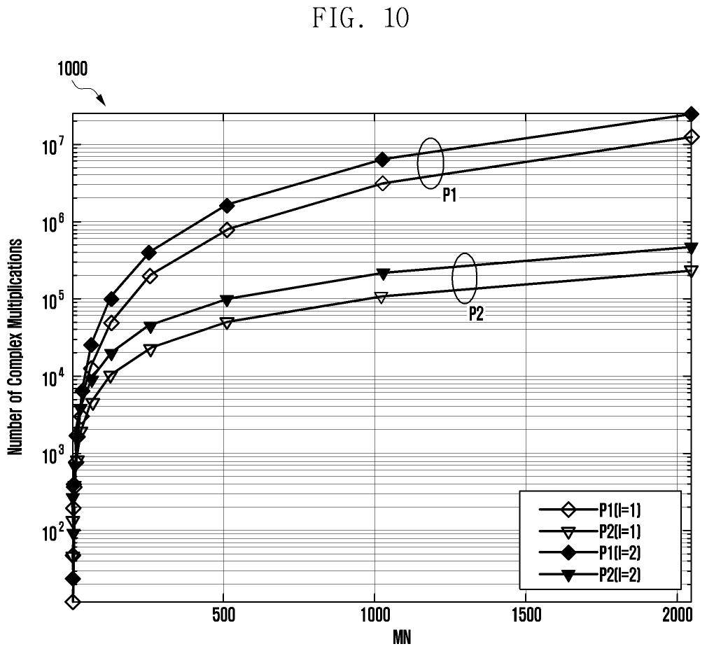

FIGS. 10-12 are graphical diagrams depicting the performance of the proposed PSS detection techniques, according to an embodiment of the present disclosure. FIG. 10 is a schematic diagram 1000 depicting a plotting of the number of complex multiplications required by methods P1 and P2 respectively with different values of DDREs (i.e., NM). For the purpose of simulation, the number of PSS that need to be correlated at the UE is set to C=3 and Ns=MN is the number of samples that will be correlated. Therefore, when I=1, the number of complex multiplications for PSS detection required by P1 and P2 is 3,145,728 and 107,520, respectively. When MN=1024, P2 requires 29 times fewer complex multiplications than P1.

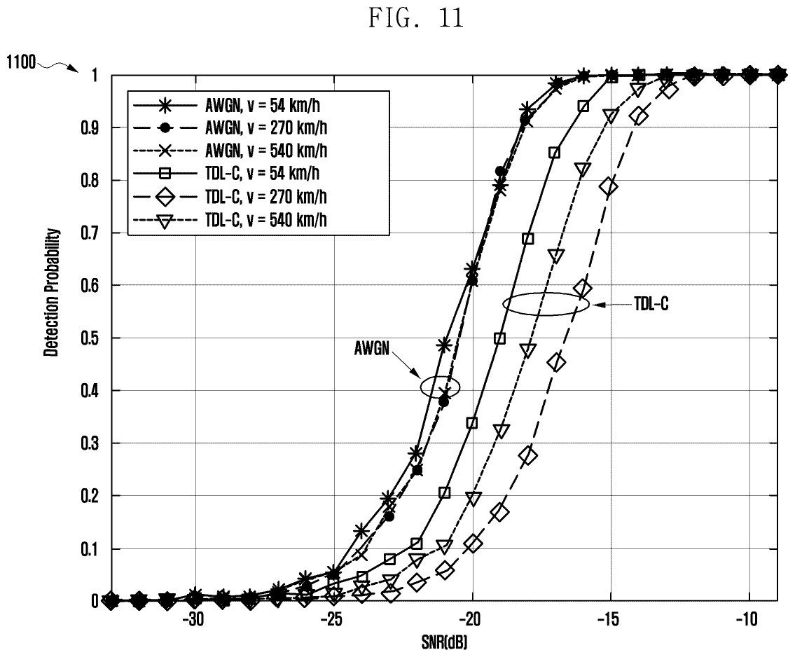

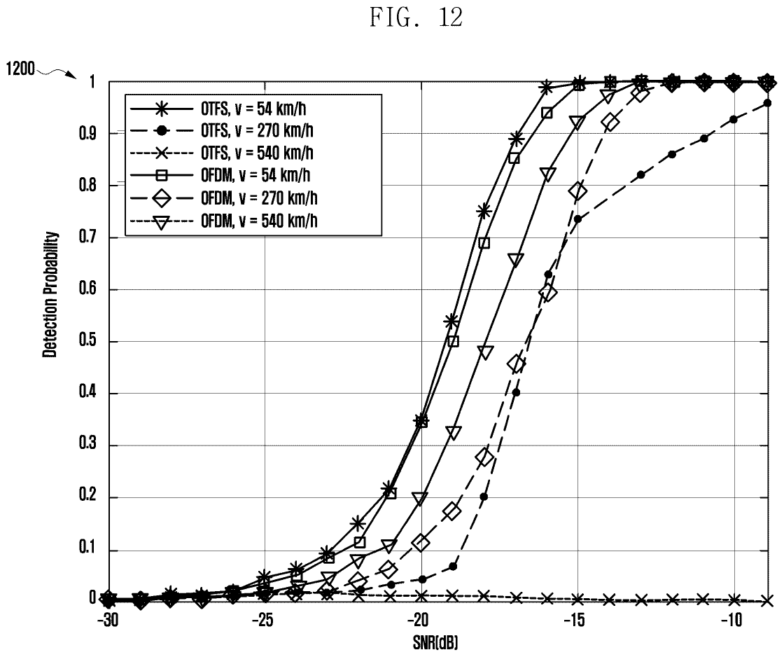

FIG. 11 is a schematic diagram 1100 depicting the detection probabilities of PSS by P2 under additive white Gaussian noise (AWGN) and tapped delay line (TDL)-C. For detection probability under AWGN, P=1 and vp=vmax are considered. The BS0 301, BS1 303, and BS2 305 may transmit corresponding PSSs with u0=11, u1=19, and u2=27, respectively and a successful detection may correspond to the case where the correct position of the start of the PSS and PCID (u0=11) are detected. It can be seen from the FIG. 12 that for all three UE velocities v={54, 270, 540} km/h corresponding to Doppler frequency values {1.4, 7, 14} kHz and AWGN case, the detection probability reaches 99% at an SNR of −16 dB. For TDL-C, the detection probability reaches 99% at SNR {−15, −12, −13} dB for UE velocities v∈={54, 270, 540} km/h, respectively. As the velocity increases, the detection probability tends to deteriorate due to the distinct Doppler values associated with each multipath component. In addition, it may be observed that the detection probability when v=270 km/h (=vmax=7 kHz Doppler frequency) is comparatively lower than v={54, 540} because the time shift in the correlation is extreme for Doppler values near to half subcarrier spacing. However, the deterioration is not significant. In embodiments of the present application, the detection probabilities obtained by P1 and P2 exhibit the same trend. As a result, the detection probability obtained by P2 alone is presented.

FIG. 12 is a schematic diagram 1200 depicting the comparative detection probabilities of the PSS using the OTFS and OFDM techniques. For a fair comparison, the parameters such as ZCS length, subcarrier spacing, and carrier frequency are kept constant and the ZCS is only mapped in one OFDM symbol. In the OFDM system, when the UE velocity is low (i.e., v=54 km/h), a 99% detection probability is obtained at an SNR of −16 dB. However, when Doppler frequency increases, the OFDM system suffers severe inter-carrier interference (ICI), causing the detection probability to degrade. When v=270 km/h, the 99% detection probability degrades by 9 dB as compared to v=54 km/h and falls to zero at all SNR regions when v=540 km/h. Thus, the proposed technique is robust against the high Doppler, whereas the detection probability of the OFDM system is reduced to zero in all SNR regions when the Doppler>Δf/2 exists. The detection probability of PSS shows that the proposed technique is robust to high Doppler environments.

After the PSS detection, SSS detection is performed. Conventionally, the SSS detection is done in the frequency domain using 1D correlation. According to the embodiments of the present disclosure, the SSS detection may be done in DD domain. To perform the SSS detection according to the embodiments of the present disclosure, 2D correlation may be required. In the first step, the received downlink frame is transformed into DD domain as follows:

The n^{th} OTFS symbol each consisting of M samples can be collected from (8) as

$$r ( nM + ℓ ) = {{\sum }^{C - 1}}_{c = 0} {{\sum }^{p}}_{p = 1} {β}_{ρ}^{c} {s}^{c} ( nM + ℓ - \frac{{τ}_{ρ}^{c}}{{T}_{\text{?}}} ) {e}^{j 2 {πυ}^{\text{?}} {T}_{\text{?}} ( nM + ℓ - \frac{\text{?}}{{T}_{\text{?}}} )} + w ( nM + ℓ ) , \qquad ( 12 )$$

$$\text{?} \text{indicates text missing or illegible when filed}$$

where 0≤l<M. Now, the sampled time-domain received signal in (12) gets transformed back to the time-frequency domain using DFT as

$$Y [ n , m ] = \frac{1}{M} {\sum }_{ℓ = 0}^{M - 1} r ( nM + ℓ ) {e}^{- j 2 π \frac{\text{?}}{M}} = \frac{1}{M} {\sum }_{ℓ = 0}^{M - 1} {\sum }_{c = 0}^{C - 1} {\sum }_{p = 0}^{P} \begin{matrix}{β}_{p}^{c} {s}^{c} ( nM + ℓ - \frac{{τ}_{p}^{c}}{{T}_{\text{?}}} ) \\ {e}^{j 2 {πυ}_{p}^{c} {T}_{\text{?}} ( nM - \frac{{τ}_{p}^{c}}{{T}_{\text{?}}} )} {e}^{- j 2 π \frac{m ℓ}{M}}\end{matrix} + \frac{1}{M} {\sum }_{ℓ = 0}^{M - 1} w ( nM + ℓ ) {e}^{- j 2 π \frac{m ℓ}{M}} = {\sum }_{c = 0}^{C - 1} {\sum }_{p = 0}^{P} {β}_{p}^{c} {e}^{j 2 {πυ}^{c} {T}_{\text{?}} ( nM - \frac{{τ}_{p}^{c}}{{T}_{\text{?}}} )} {e}^{- j 2 π \frac{m}{M}} \frac{{τ}_{p}^{c}}{{T}_{\text{?}}} {X}^{c} [ n , m ] + W [ n , m ] , \qquad ( 13 )$$

$$\text{?} \text{indicates text missing or illegible when filed}$$

and to transform the time-frequency domain signal in (13) to the delay-Doppler domain, SFFT is applied as

$$y [ k , l ] = {\sum }_{n = 0}^{N - 1} {\sum }_{m = 0}^{M - 1} Y [ n , m ] {e}^{j 2 π ( \frac{m \text{?}}{M} - \frac{nk}{N} )} = {\sum }_{n = 0}^{N - 1} {\sum }_{m = 0}^{M - 1} {\sum }_{c = 0}^{C - 1} {\sum }_{p = 1}^{P} {β}_{p}^{c} {e}^{j 2 {πυ}^{c} {T}_{\text{?}} ( nM - \frac{{τ}_{p}^{c}}{{T}_{\text{?}}} )} {e}^{- j 2 π \frac{m}{M} \frac{{τ}_{p}^{c}}{{T}_{\text{?}}}} + {\sum }_{n = 0}^{N - 1} {\sum }_{m = 0}^{M - 1} W [ n , m ] {e}^{j 2 π ( \frac{m \text{?}}{M} - \frac{nk}{N} )} = {\sum }_{c = 0}^{C - 1} {\sum }_{p = 1}^{P} {β}_{p}^{c} {x}^{c} [ {( k - {k}_{p}^{c} )}_{N} , {( l - {l}_{p}^{c} )}_{M} + \hat{w} [ k , l ] , \qquad ( 14 )$$

$$\text{?} \text{indicates text missing or illegible when filed}$$

where (·)M and (·)N represent modulo M and N operations, respectively. In (14), the SCID signal from multiple neighbouring BSs is superimposed and the desired signal needs to be detected in the presence of interference and AWGN. At step 2, 2D DD domain correlation with a locally generated DD SSS is performed and SCID corresponding to the SSS in the received downlink frame is estimated. In an embodiment, when SSS is a ZCS, the correlation property for the same is derived as follows:

When the local DD ZC sequence x^{c′}[k,l] is correlated with the received DD ZC sequence after passing through the channel with k^{c} Doppler shift l^{c} delay shift, the correlation function with k′ lags in Doppler domain l′ lags in the delay domain may be given as equation (15).

$${Z}^{c , {c}^{′}} [ {k}^{′} , {l}^{′} ] = {\sum }_{k = 0}^{N - 1} {\sum }_{l = 0}^{M - 1} {x}^{c} [ k - {k}^{c} , l - {l}^{c} ] {( {x}^{{c}^{′}} [ k - {k}^{′} , l - {l}^{′} ] )}^{*} = {e}^{\frac{j π}{MN} [ {u}^{c} ( {l}^{c} + {k}^{c} M ) ( {l}^{c} + {k}^{c} M - 1 ) - {u}^{{c}^{′}} ( {l}^{′} + {k}^{′} M ) ( {l}^{′} + {k}^{′} M - 1 ) ]} {\sum }_{k = 0}^{N - 1} {\sum }_{l = 0}^{M - 1} {e}^{- \frac{j π}{MN} ( {u}^{c} - {u}^{{c}^{′}} ) ( l + kM ) ( l + kM + 1 )} {e}^{\frac{j 2 π}{MN} ( l + kM ) ( {u}^{c} ( {l}^{c} + {k}^{c} M ) - {u}^{{c}^{′}} ( {l}^{′} + {k}^{′} M )} ) \qquad ( 15 )$$

where c∈C−1 and C is the number of BSs. The autocorrelation property of the ZCS SSS may be derived using the equation (16). When u^{c}=u^{c′}, the autocorrelation can be given as

$${Z}^{c , c} [ {k}^{′} , {l}^{′} ] = \{ \begin{matrix}MN δ [ {( {k}^{u} )}_{{N}^{′}} {( {l}^{u} )}_{M} ] , & {k}^{u} = {k}^{′} , {l}^{u} = {l}^{′} \\ 0 , & {k}^{u} \neq {k}^{′} , {l}^{u} \neq {l}^{′}\end{matrix} \qquad ( 16 )$$

In an embodiment, the autocorrelation function of DD ZC sequence is non-zero only when the delay and Doppler shifts by the channel match with the delay and Doppler correlation lags. Further, when u^{c}≠u^{c′}, the cross-correlation of ZC SSS may be given as equation (17), using the Gauss Sum property:

$${Z}^{c , {c}^{′}} [ {k}^{′} , {l}^{′} ] = {e}^{- \frac{j π}{MN} [ {u}^{c} ( {l}^{c} + {k}^{c} M ) ( {l}^{c} + {k}^{c} M - 1 ) + {u}^{c} ( {l}^{c} + {k}^{c} M ) - {u}^{{c}^{′}} ( {l}^{′} + {k}^{′} M ) ( {l}^{′} + {k}^{′} M - 1 ) - {u}^{{c}^{′}} ( {l}^{′} + {k}^{′} M ) ( {l}^{′} + {k}^{′} M ) ]} {e}^{\frac{j π}{MN} {{( {u}^{c} - {u}^{{c}^{′}} )}^{- 1} [ {u}^{c} ( {l}^{c} + {k}^{c} M ) - {u}^{{c}^{′}} ( {l}^{′} + {k}^{′} M ) ]}^{2}} \times {\sum }_{k = 0}^{N - 1} {\sum }_{l = 0}^{M - 1} {e}^{- \frac{j π}{MN} ( {u}^{c} - {u}^{{c}^{′}} ) [ ( l + kM ) - {( {u}^{c} - {u}^{{c}^{′}} )}^{- 1} ( {u}^{c} ( {l}^{c} + {k}^{c} M ) - {u}^{{c}^{′}} ( {l}^{′} + {k}^{′} M ) ) ) ( ( l + kM ) - {( {u}^{c} - {u}^{{c}^{′}} )}^{- 1} ( {u}^{c} ( {l}^{c} + {k}^{c} M ) - {u}^{{c}^{′}} ( {l}^{′} + {k}^{′} M ) ]} = {e}^{- \frac{j π}{MN} [ {{u}^{c} ( {l}^{c} + {k}^{c} M )}^{2} -} {u}^{{c}^{′} {{u}^{{c}^{′}} ( {l}^{′} + {k}^{′} M )}^{2} ]} {e}^{\frac{j π}{MN} ( {{( {u}^{c} - {u}^{{c}^{′}} )}^{- 1} [ {u}^{c} ( {l}^{c} + {k}^{c} M ) - {u}^{{c}^{′}} ( {l}^{′} + {k}^{′} M ) ]}^{2}} {\sum }_{k = 0}^{N - 1} {\sum }_{l = 0}^{M - 1} {e}^{- \frac{j π}{MN} ( {u}^{c} - {u}^{{c}^{′}} ) ( l + kM ) ( l + kM + 1 )} \qquad ( 17 )$$

$${\sum }_{k = 0}^{N - 1} {\sum }_{l = 0}^{M - 1} {e}^{- \frac{j π}{MN} ( {u}^{c} - {u}^{{c}^{′}} ) ( l + kM ) ( l + kM + 1 )} = \sqrt{MN} {e}^{\frac{j 2 π}{MN}} ( {u}^{c} - {u}^{{c}^{′}} ) {ηχ}^{2} Θ , where$$

$$〈 \frac{η \vert {u}^{c} - {u}^{{c}^{′}} \vert}{MN} 〉 \{ \begin{matrix}\frac{1 - {j}^{MN}}{1 - j} , & {u}^{c} > {u}^{{c}^{′}} \\ \frac{1 + {j}^{MN}}{1 + j} , & {u}^{c} < {u}^{{c}^{′}}\end{matrix} , η = \frac{MN + 1}{2} , χ = \frac{MN - 1}{2} ,$$

and [symbol] is the Jacobi symbol.

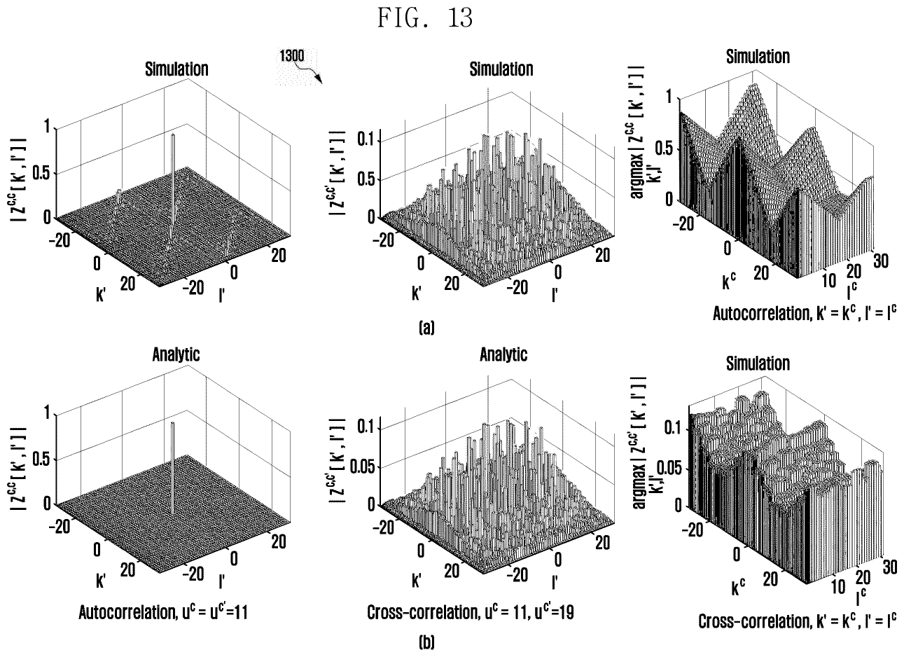

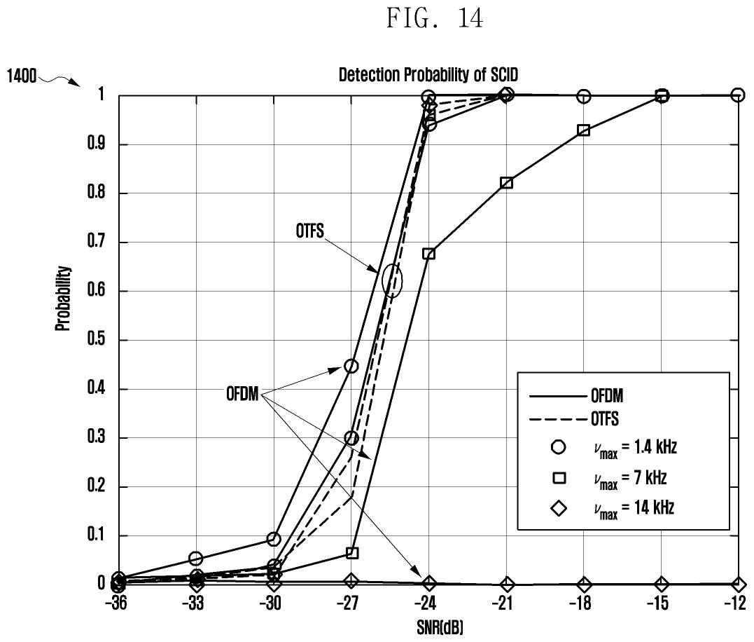

FIG. 13 is a schematic diagram 1300 illustrating the correlation properties of the 2D delay-Doppler ZCS. From the left figure of notation “a” in FIG. 13, it can be seen that the normalized autocorrelation value between the received SCID (u^{c}=11) and reference SCID (u^{c}=11) becomes high only at k′=k^{c}=0 and l′=l^{c}=0, otherwise it is zero. In addition, the center figure of notation “a” in FIG. 14 shows the maximum normalized autocorrelation values for k^{c}∈[−31, 31] and l^{c}∈[0, 31]. From this figure, it can be seen that when k′=k^{c}=0 and l′=l^{c}/=0, the peak value of normalized autocorrelation relation decreases and shifts corresponding to the value of kc and lc. Similarly, the left figure of notation “b” in FIG. 14 shows the normalized cross-correlation value between the received SCID (u^{c}=11) and reference. SCID (u^{c′}=19) for k^{c}=l^{c}=0 and the center figure of notation “b” in in FIG. 14 shows the normalized cross-correlation values for k=k^{c}∈[−31, 31] and l=l^{c}∈[0, 31]. From these figures, it can be seen that the maximum normalized cross-correlation value at k^{c}=l^{c}=0 is approximately equal to 0.1185 which is approximately four times higher than 1/\sqrt{ }MN=0.0313. The difference is because of the selection of even length ZCS (MN=1024) and the OTFS modulation performed on ZCS. In addition, the analytic results obtained in (16) and (17) are plotted at the right of FIG. 14. These figures show that the analytic and simulation results coincide well.

Further, the performance of the proposed synchronization technique for OTFS is evaluated via computer simulations. A simple cellular model may be used where it is considered that a UE is moving from BS0 (u⁰=11) to BS1 (u^{l}=19) on a given trajectory and each BS has a cell radius of 100 m. The carrier frequency fc and Δf are set to 28 GHz and 15 kHz, respectively. For the channel, the 3GPP tapped delay line-C (TDL-C) model with a delay spread of 300 ns is considered. For the c^{th} BS,

$${υ}_{p}^{c} = {υ}_{max} cos ( {θ}_{p}^{c} )$$

for the p^{th} path, where

$${θ}_{p}^{c} ∈ [ 0 , 2 π )$$

is independent and uniformly distributed. The simulation parameters for OTFS are summarized in Table I.

TABLE I
OTFS parameter set

| | |
|---|---|
| Parameter | Value |

| Carrier Frequency, f_{c} | 28 | GHz |
|---|---|---|
| OTFS Symbol Size, [N, M] | [32, 32] | |
| Maximum Doppler Spread, νₘₐₓ | {1.4, 7, 14} | kHz |
| Channel Model | TDL-C, 300 ns delay spread | |
| Subcarrier spacing, Δf | 15 | kHz |
| Doppler resolution, 1/NT | 468.75 | Hz |
| Doppler resolution, 1/MΔf | 2.1 | μs |

FIG. 14 is a schematic diagram 1400 illustrating the comparative detection probabilities of the SCID using the OTFS and OFDM techniques. Here, it is assumed that the ST is already performed, and BS0, BS1, and BS2 transmit SCIDs with u⁰=11, u¹=19, and u²=27, respectively. A successful detection corresponds to the case where the correct SCID (u⁰=19) is detected. It can be seen from the figure that for all three Doppler frequency values (1.4 kHz, 7 kHz, and 14 kHz), the detection probability reaches 100% at an SNR of −21 dB using the proposed method. The Doppler frequency values {1.4, 7, 14} kHz correspond to {15, 75, and 150} m/s UE speeds. In addition, the detection probability is compared with the results obtained with the OFDM technique. For a fair comparison, the parameters such as ZCS length, subcarrier spacing, and carrier frequency are kept constant and the ZCS is only mapped in one OFDM symbol. In the OFDM system, when the Doppler frequency is low (i.e., vₘₐₓ=1.4 kHz), a 100% detection probability is obtained at an SNR of −21 dB. However, when Doppler frequency increases, the OFDM system suffers severe inter-carrier interference (ICI), causing the detection probability to degrade. When vₘₐₓ=7 kHz, the detection probability degrades by 6 dB as compared to vₘₐₓ=1.4 kHz and falls to zero at all SNR regions when vₘₐₓ=14 kHz. Thus, the proposed method is robust against the high Doppler, whereas the detection probability of the OFDM system is reduced to zero in all SNR regions when the Doppler>Δf/2 exists.

In an exemplary embodiment, a secondary synchronization signal detection technique or detecting SCID using OTFS at the physical layer is shown. SCID is generated using ZCS and is detected noncoherently in the delay-Doppler domain. Different from the traditional 1D correlation properties, the 2D correlation properties of ZCS have been evaluated, and the results show that the 2D ZCS provides ideal autocorrelation and good cross-correlation properties. Finally, the detection probability of SCID shows that the proposed method is robust to high Doppler environments. In addition, the detection probability obtained by OFDM significantly decreases in a high Doppler environment which is undesirable. Besides, the proposed method has a significantly lower computational complexity.

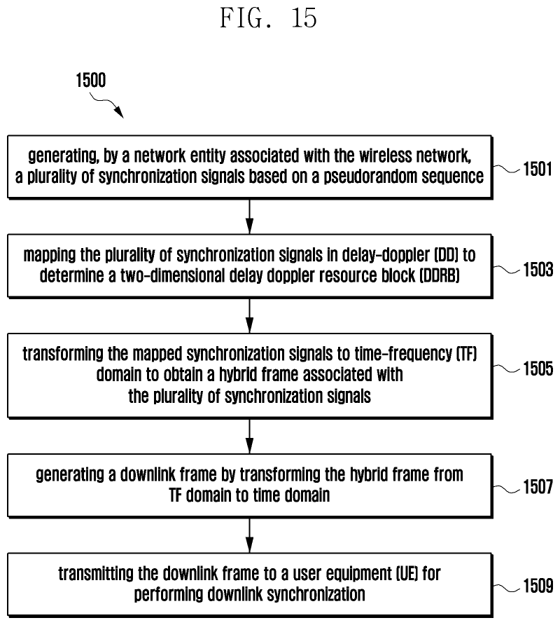

FIG. 15 is a flow diagram depicting the method 1500 for performing downlink synchronization, according to an embodiment of the present disclosure. The method 1500, at step 1501, includes generating, by a network entity associated with the wireless network, a plurality of synchronization signals based on a pseudorandom sequence. In an embodiment, the network entity may be a base station. In an embodiment, the pseudorandom sequence corresponds to at least one of Zadoff-Chu sequence, m-sequence, and gold sequence based on a radio access technology being used in the wireless network, and a type of the plurality of synchronization signals.

Thereafter the method 1500, at step 1503, includes mapping the plurality of synchronization signals in delay-Doppler (DD) to determine a two-dimensional delay Doppler resource block (DDRB). In an embodiment, mapping of the plurality of synchronization signals is performed using a scheme, wherein parts of the synchronization signals are separated in the DDRB based on delay and Doppler symbols associated with time and frequency in time-frequency domain, respectively. In an embodiment, the DDRB comprises M partitions in the delay domain and N partitions in Doppler domain, and wherein the M partitions are associated with M resource elements (REs) in delay domain, and N partitions are associated with N REs in Doppler domain.

Thereafter the method 1500, at step 1505, includes transforming the mapped synchronization signals to time-frequency (TF) domain to obtain a hybrid frame associated with the plurality of synchronization signals. In an embodiment, the hybrid frame includes the DD domain synchronization signals transformed in TF domain, and data mapped in TF domain. Thereafter the method 1500, at step 1507, includes transforming the mapped synchronization signals to time-frequency (TF) domain to obtain a hybrid frame associated with the plurality of synchronization signals. Upon transforming the mapped synchronization signals, the method 1500, at step 1509, includes generating a downlink frame by transforming the hybrid frame from TF domain to time domain. Finally, the method, at step 1611, includes transmitting the downlink frame to a user equipment (UE) for performing downlink synchronization.

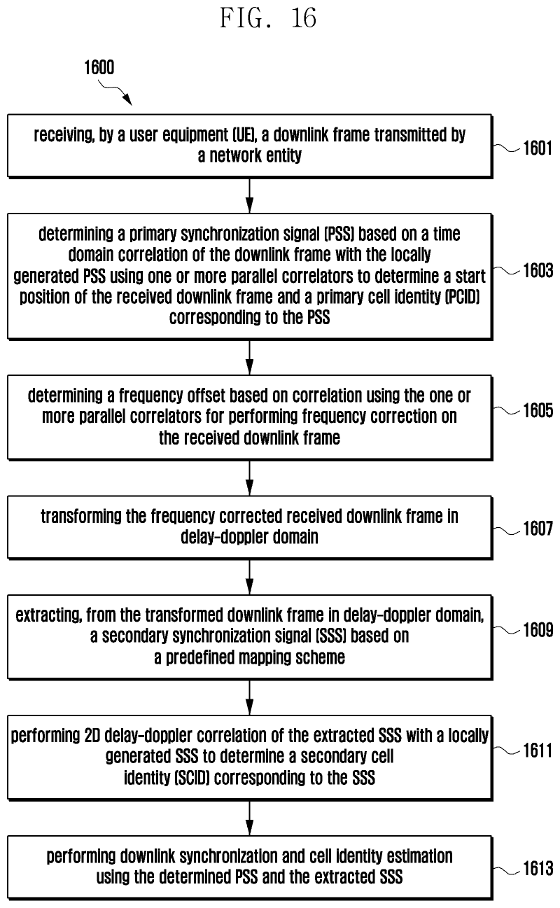

FIG. 16 is a flow diagram depicting the method 1600 for performing downlink synchronization, according to an embodiment of the present disclosure. The method 1600, at step 1601, includes receiving, by a user equipment (UE), a downlink frame transmitted by a network entity. Thereafter the method 1600, at step 1603, includes determining a primary synchronization signal (PSS) based on a time domain correlation of the downlink frame with the locally generated PSS using one or more parallel correlators to determine a start position of the received downlink frame and a primary cell identity (PCID) corresponding to the PSS. Thereafter the method 1600, at step 1605, includes determining a frequency offset based on correlation using the one or more parallel correlators for performing frequency correction on the received downlink frame. Thereafter the method 1600, at step 1607, includes transforming the frequency corrected received downlink frame in delay-Doppler domain. Thereafter the method 1600, at step 1607, includes extracting, from the transformed downlink frame in delay-Doppler domain, a secondary synchronization signal (SSS) based on a predefined mapping scheme. Thereafter the method 1600, at step 1609, includes performing 2D delay-Doppler correlation of the extracted SSS with a locally generated SSS to determine a secondary cell identity (SCID) corresponding to the SSS. Finally, the method 1600, at step 1611, includes performing downlink synchronization and cell identity estimation using the determined PSS and the extracted SSS.

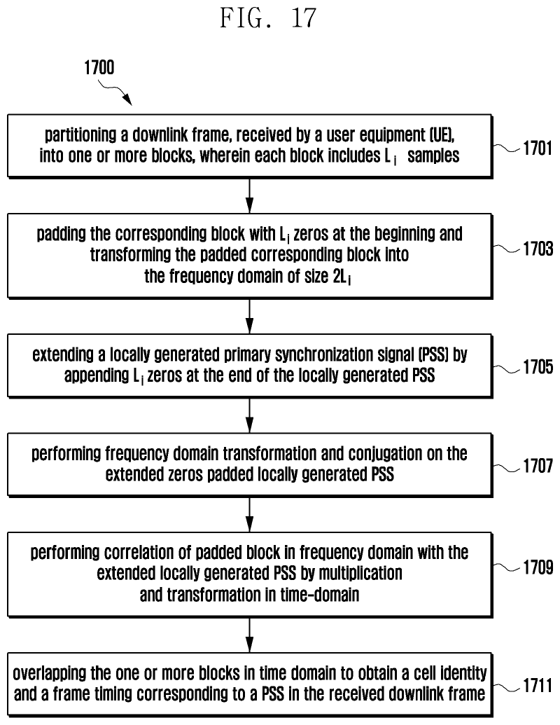

FIG. 17 is a flow diagram depicting the method 1700 for performing PSS detection, according to an embodiment of the present disclosure. The method 1700, at step 1701, includes partitioning a downlink frame, received by a user equipment (UE), into one or more blocks, wherein each block includes L_{I} samples. For each block of the one or more blocks, the method 1700, at step 1703, includes padding the corresponding block with L_{I} zeros at the beginning and transforming the padded corresponding block into the frequency domain of size 2L_{I}. Thereafter, the method, at step 1705, includes extending a locally generated primary synchronization signal (PSS) by appending L_{I} zeros at the end of the locally generated PSS. Thereafter the method 1700, at step 1707, includes performing frequency domain transformation and conjugation on the extended zeros padded locally generated PSS. Thereafter, the method 1700, at step 1709, includes performing correlation of padded block in frequency domain with the extended locally generated PSS by multiplication and transformation in time-domain.

Finally, the method 1700 includes, at step 1711, overlapping the one or more blocks in time domain to obtain a cell identity and a frame timing corresponding to a PSS in the received downlink frame. After overlapping each block, the method 1700 includes at step 1713, discarding the L_{I} samples from the beginning and ending of the overlapped blocks in the time domain.

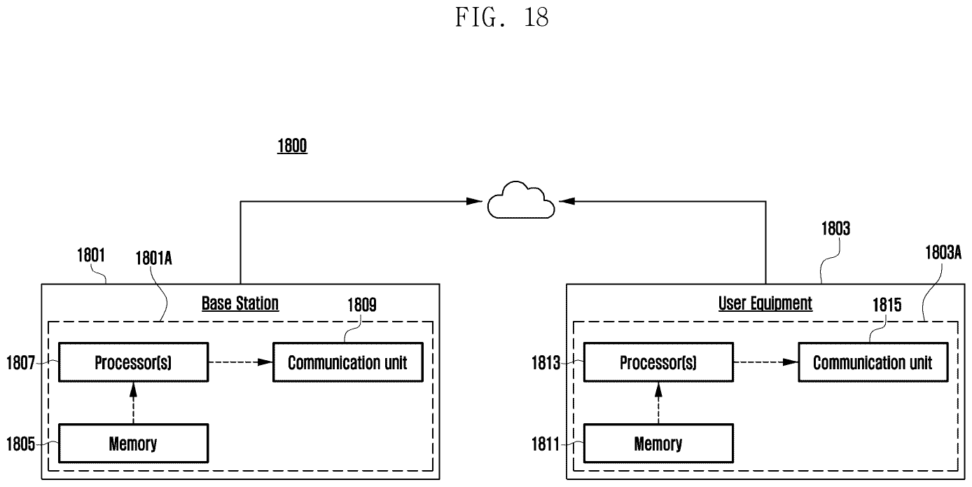

FIG. 18 is a block diagram 1800 depicting an overall system for implementing the proposed techniques for performing downlink synchronization. As shown in the figure, a BS 1801 may be communicatively coupled with a UE 1803. While the FIG. 18 depicts one BS, multiple BSs may also be present as shown in FIG. 3. The BS 1801 may comprise a system 1801A configured to generate a downlink frame in accordance with the embodiments of the present disclosure. The system 1801A may include a memory 1805, at least one processor 1807 coupled with the memory 1805 and configured to perform the proposed method 1500 for performing downlink synchronization, and a communication unit 1809 (e.g., communicator or communication interface). The communication unit 1809 may perform one or more functions for transmitting and receiving signals via a wireless channel.

The memory 1805 stores instructions to be executed by the processor 1807. The memory 1805 may include one or more computer-readable storage media. The memory 1805 may include non-volatile storage elements. Examples of such non-volatile storage elements may include magnetic hard discs, optical discs, floppy discs, Solid State Drives (SSDs), Non-Volatile Memory Express (NVMe), Non-volatile Dual In-line Memory Module (NVDIMM), Non-Volatile Random Access Memory (NVRAM), Non-volatile SRAM (NVSRAM), flash memories, or forms of electrically programmable memories (EPROM) or electrically erasable and programmable (EEPROM) memories. In addition, the memory 1805 may, in some examples, be considered a non-transitory storage medium. The term “non-transitory” may indicate that the storage medium is not embodied in a carrier wave or a propagated signal. However, the term “non-transitory” should not be interpreted that the memory 1805 is non-movable. In some examples, the memory 1805 can be configured to store larger amounts of information. In certain examples, a non-transitory storage medium may store data that can, over time, change (e.g., in Random Access Memory (RAM) or cache).

The processor 1807 is configured to execute instructions stored in the memory 1805 and to perform various operations as disclosed in the present disclosure. The processor 1807 may be operatively coupled to the memory 1805 for processing, executing, or performing a set of operations. The processor 1807 may include specialized processing units such as integrated system (bus) controllers, memory management control units, floating point units, graphics processing units, digital signal processing units, etc. In one embodiment, the processor 1807 may include a central processing unit (CPU), a graphics processing unit (GPU), or both. The processor 1807 may be one or more general processors, digital signal processors, application-specific integrated circuits, field-programmable gate arrays, servers, networks, digital circuits, analog circuits, combinations thereof, or other now-known or later developed devices for analyzing and processing data. The processor 1807 may execute one or more instructions, such as code generated manually (i.e., programmed) to perform one or more operations disclosed herein throughout the disclosure.

The UE 1803 may comprise a system 1805A configured to detect PSS and SSS in accordance with the embodiments of the present disclosure. The system 1805A may include a memory 1811, and at least one processor 1813 coupled with the memory 1809 and configured to perform the proposed method 1600 or 1700 for performing downlink synchronization, and a communication unit 1815 (e.g., communicator or communication interface). The memory 1809, and the processor 1811 may have similar hardware characteristics as the memory 1805, and processor 1807. The same are not described herein for the sake of brevity.

Disclosed (1500, 1600, 1700) is a method and system (1801A, 1803A) for performing downlink synchronization in a wireless network. Initially, a plurality of synchronization signals generated based on a pseudorandom sequence by a network entity associated with the wireless network. Further, the plurality of synchronization signals are mapped in delay-Doppler (DD) domain to determine a two-dimensional delay Doppler resource block (DDRB). Furthermore, the mapped synchronization signals are transformed to the time-frequency (TF) domain to obtain a hybrid frame associated with the plurality of synchronization signals. Moreover, a downlink frame is generated by transforming the hybrid frame from TF domain to the time domain. Finally, the downlink frame is transmitted to a user equipment (UE) for performing downlink synchronization.

Unless otherwise defined, all technical and scientific terms used herein have the same meaning as commonly understood by one ordinary skilled in the art to which this invention belongs. The system, methods, and examples provided herein are illustrative only and not intended to be limiting.

While specific language has been used to describe the present subject matter, any limitations arising on account thereto, are not intended. As would be apparent to a person in the art, various working modifications may be made to the method to implement the inventive concept as taught herein. The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment

The embodiments disclosed herein can be implemented using at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method performed by a base station in a wireless communication system, the method comprising:
generating a plurality of synchronization signals based on a pseudorandom sequence;
mapping the plurality of synchronization signals in delay-Doppler (DD) to determine a two-dimensional delay-Doppler resource block (DDRB);
transforming the mapped synchronization signals to a time-frequency (TF) domain to obtain a hybrid frame associated with the plurality of synchronization signals;
generating a downlink frame by transforming the hybrid frame from TF domain to a time domain; and
transmitting the downlink frame to a terminal for performing downlink synchronization.

2. The method of claim 1, wherein the mapping of the plurality of synchronization signals is performed using a scheme, wherein parts of the synchronization signals are separated in the DDRB based on delay and Doppler symbols associated with time and frequency in time-frequency domain, respectively.

3. The method of claim 1, wherein the pseudorandom sequence corresponds to at least one of Zadoff-Chu sequence, m-sequence, and gold sequence based on a radio access technology being used in a wireless network, and a type of the plurality of synchronization signals.

4. The method of claim 1, wherein the DDRB comprises M partitions in a delay domain and N partitions in Doppler domain, and wherein the M partitions are associated with M resource elements (REs) in delay domain, and N partitions are associated with N REs in Doppler domain.

5. The method of claim 1, wherein the hybrid frame comprises the DD domain synchronization signals transformed in TF domain, and data mapped in TF domain.

6. A system base station in a wireless communication system, the base station comprising:
a transceiver; and
at least one processor coupled with the transceiver and configured to:
generate a plurality of synchronization signals based on a pseudorandom sequence,
map the plurality of synchronization signals in delay-Doppler (DD) to determine a two-dimensional delay Doppler resource block (DDRB),
transform the mapped synchronization signals to time-frequency (TF) domain to obtain a hybrid frame associated with the plurality of synchronization signals,
generate a downlink frame by transforming the hybrid frame from the TF domain to a time domain, and
transmit the downlink frame to a terminal for performing downlink synchronization.

7. The base station of claim 6, wherein the mapping of the plurality of synchronization signals is performed using a scheme, wherein parts of the synchronization signals are separated in the DDRB based on delay and Doppler symbols associated with time and frequency in a time-frequency domain, respectively.

8. The base station of claim 6, wherein the pseudorandom sequence corresponds to at least one of Zadoff-Chu sequence, m-sequence, and gold sequence based on a radio access technology being used in a wireless network, and a type of the plurality of synchronization signals.

9. The base station of claim 6, wherein the DDRB comprises M partitions in a delay domain and N partitions in Doppler domain, and wherein the M partitions are associated with M resource elements (REs) in delay domain, and N partitions are associated with N REs in Doppler domain.

10. A method performed by a terminal in a wireless communication system, the method comprising:
receiving, from a base station, a downlink frame;
determining a primary synchronization signal (PSS) based on a time domain correlation of the downlink frame with the locally generated PSS using one or more parallel correlators to determine a start position of the received downlink frame and a primary cell identity (PCID) corresponding to the PSS;
determining a frequency offset based on correlation using the one or more parallel correlators for performing frequency correction on the received downlink frame;
transforming the frequency corrected received downlink frame in delay-Doppler domain;
extracting, from the transformed downlink frame in delay-Doppler domain, a secondary synchronization signal (SSS) based on a predefined mapping scheme;
performing 2D delay-Doppler correlation of the extracted SSS with a locally generated SSS to determine a secondary cell identity (SCID) corresponding to the SSS; and
performing downlink synchronization and cell identity estimation using the determined PSS and the extracted SSS.

11. A terminal in a wireless communication system, the terminal comprising:
a transceiver; and
at least one processor coupled with the transceiver and configured to:
receive, from a base station, a downlink frame,
determine a primary synchronization signal (PSS) based on a time domain correlation of the downlink frame with the locally generated PSS using one or more parallel correlators to determine a start position of the received downlink frame and a primary cell identity (PCID) corresponding to the PSS,
determine a frequency offset based on correlation using the one or more parallel correlators for performing frequency correction on the received downlink frame,
transform the frequency corrected received downlink frame in delay-Doppler domain,
extract, from the transformed downlink frame in delay-Doppler domain, a secondary synchronization signal (SSS) based on a predefined mapping scheme,
perform 2D delay-Doppler correlation of the extracted SSS with a locally generated SSS to determine a secondary cell identity (SCID) corresponding to the SSS, and
perform downlink synchronization and cell identity estimation using the determined PSS and the extracted SSS.

12. The method of claim 10, wherein the determining the PSS comprises:
partitioning the downlink frame into one or more blocks, wherein each block includes LI samples,
for each block of the one or more blocks:
padding the corresponding block with LI zeros at the beginning and transforming the padded corresponding block into a frequency domain of size 2LI;
extending the locally generated PSS by appending LI zeros at the end of the locally generated PSS;
performing frequency domain transformation and conjugation on the extended zeros padded locally generated PSS; and
performing correlation of padded block in frequency domain with the extended locally generated PSS by multiplication and transformation in time-domain; and
overlapping the one or more blocks in time domain to obtain a cell identity and a frame timing corresponding to a PSS in the received downlink frame.

13. The method of claim 12, wherein after overlapping each block, the method comprises:
discarding the LI samples from beginning and ending of the overlapped blocks in time domain.

14. The terminal of claim 11, wherein the at least one processor is further configured to:
partition the downlink frame into one or more blocks, wherein each block includes LI samples,
for each block of the one or more blocks:
perform padding the corresponding block with LI zeros at the beginning and transforming the padded corresponding block into a frequency domain of size 2LI,
extend the locally generated PSS by appending LI zeros at the end of the locally generated PSS,
perform frequency domain transformation and conjugation on the extended zeros padded locally generated PSS, and
perform correlation of padded block in frequency domain with the extended locally generated PSS by multiplication and transformation in time-domain, and
perform overlapping the one or more blocks in time domain to obtain a cell identity and a frame timing corresponding to a PSS in the received downlink frame.

15. The terminal of claim 14, wherein after overlapping each block, the at least one processor is further configured to:
discard the LI samples from beginning and ending of the overlapped blocks in time domain.
